(19) United States
(12) Patent Application Publication
(10) Pub. No.: US 2008/0189962 A1
(43) Pub. Date: Aug. 14, 2008

(54) Reciprocating saw and in particular a jig saw

(76) Inventors: Torsten Reuss, D-Dettingen unter Teck (DE); Volker Kretschmar, Koengen (DE)

Correspondence Address: FLYNN THIEL BOUTELL & TANIS, P.C., 2026 RAMBLING ROAD, KALAMAZOO, MI, 49008-1631, US

(21) Appl. No.: 12/012,032

(22) Filed: Jan. 31, 2008

(30) Foreign Application Priority Data
Feb. 9, 2007 (DE) 10 2007 006 482.0

(51) Int. Cl. B23D 49/16; B27B 19/02

(52) U.S. Cl. 30/393

(57) ABSTRACT

A reciprocatory saw and in particular a jig saw comprises a drive means for driving a saw blade with an elongated configuration to perform a reciprocating movement. The saw blade possesses two mutually parallel side faces and its leading edge is designed for working a workpiece with a sawing action. The back edge of saw blade is provided with a pendulum roller which is arranged on a pendulum roller holder which is carried on a pendulum axis for reciprocating pendulum movement and during operation performs a pendulum movement so that the saw blade performs a reciprocating movement with a modulating pendulum component. For the lateral guidance of the saw blade two guide elements are present which are arranged on a guide holder supported in a pivotal manner on the pivot axis parallel to the pendulum axis. The guide holder constitutes a support means for the rear edge of saw blade with the result that the guide holder performs, while keeping its alignment in relation to the saw blade, a reciprocating pivotal movement corresponding to the pendulum components of the reciprocating motion of the saw blade.

### BACKGROUND OF THE INVENTION

The invention relates to a reciprocatory saw, and in particular a jig saw, comprising a drive means for driving a saw blade with an elongated shape having two mutually parallel side faces and at a front edge adapted for working on a workpiece by sawing, for performing a reciprocating movement to and fro, a pendulum roller for engaging the rear edge of the saw blade and being arranged on a pendulum roller holder mounted for pendulum motion on a pendulum axis performing a reciprocating pendulum movement during operation so that the saw blade performs reciprocating movement modulated by a pendulum component and two guide elements for lateral guidance of the saw blade on its two side faces.

### THE PRIOR ART

In the case of reciprocating saws of this type for example disclose in the German patent publication DE 41 21 898 A1 the guide elements are disposed in a stationary fashion on the reciprocating saw so that during operation the saw blade performs a movement in relation to the guide elements corresponding to the pendulum components of the saw blade movement.

### SHORT SUMMARY OF THE INVENTION

One object of the invention taking this prior art into account is to provide a reciprocatory saw of the type initially mentioned in which the saw blade is guided with maximum stability and minimum wear.

Accordingly to achieve this aim in a saw of the initially described type the guide elements in accordance with the invention are arranged on a guide holder, which is pivotally mounted on a pivot axis parallel to the pendulum axis, and constitutes a support means for the rear edge of saw blade engaging same during operation so that the guide holder, while maintaining its alignment in relation to the saw blade, performs a reciprocating pivotal movement corresponding to the pendulum components of the reciprocating motion of the saw blade.

Accordingly the saw blade and the guide holder and furthermore also the guide elements perform a synchronous pendulum movement with the result that only a linear relative movement takes place between the saw blade and the guide element in the longitudinal direction of the saw blade. Therefore the distance between the saw's front edge and the guide elements keeps the same at all times, something which improves the stability of the guiding action for the saw blade. Moreover, the saw blade is not backed up only by a conventional pendulum roller but also by the support means of the guide holder, something which further enhances the firmness of the guiding action. In this respect the support means ensures that the guide holder always assumes a pivotal position corresponding to the pendulum position of the saw blade.

The measures in accordance with the invention are comparatively simple to implement so that an economic design is created.

A particularly advantageous feature is such that the two guide elements are respectively constituted by an eccentric element rotatably carried on the guide element for turning about an eccentric element axis parallel to the longitudinal direction of the saw blade and so loaded by a spring means that the turning of the respective eccentric element occurs in a direction increasing the distance between the two eccentric elements against the spring force. Accordingly the guide elements automatically adapt themselves to the thickness of the respective saw blade employed with the result that the user does not have to perform any further actions for adjustment of the guide elements. The guide elements are firmly held by the spring force against the saw blade in a manner independently of the thickness of the saw blade.

The two eccentric elements are preferably so orientated that in the absence of a saw blade they delimit a blade receiving gap for the insertion of the saw blade with its rear edge to the fore, the blade receiving gap being widened on rotating the eccentric elements in a direction of turning corresponding to the direction of insertion of the saw blade against the spring force. During fitting the saw blade same is simply thrust between the two eccentric elements from the front which give way to the side against the spring forces exerted on them. For the removal of the saw blade it is simply pulled out toward the front.

Owing to the parallel alignment of the eccentric element axis in relation to the longitudinal direction of the saw blade the eccentric elements may be practically made with any desired length so that there is a corresponding lateral guidance of the saw blade over a large area. In this connection the two eccentric elements each have at least two separate eccentric members disposed with an axial clearance between them, which are joined firmly together by an eccentric member rotatably carried on the guide element.

There additional features of the invention defined in the claims.

Further advantageous developments and convenient forms of the invention will be understood from the following detailed descriptive disclosure of one embodiment thereof in conjunction with the accompanying drawings.

### LIST OF THE SEVERAL VIEWS OF THE FIGURES

FIG. 1 shows a reciprocatory saw in accordance with the invention in the form of a jig saw in a partial side elevation, the part thereof presently of interest being depicted in a longitudinal section.

FIG. 2 shows the saw blade with the pendulum roller holder and the guide holder in a separate view from the side.

FIG. 3 shows the arrangement of FIG. 2 as viewed obliquely.

FIG. 4 shows the guide holder in a separate representation as viewed obliquely from the front.

FIG. 5 shows the pendulum roller with the guide holder, viewed in section, and the saw blade in a lateral oblique view.

FIG. 6 shows the two eccentric elements constituting the guide element (without the other guide holder) and the saw blade, disposed between the two eccentric elements in an oblique elevation.

FIGS. 7 through 9 respectively show the arrangement of FIG. 6 with a saw blade having a different thickness in an end-on view looking in the direction of the arrow VII in FIG. 6.

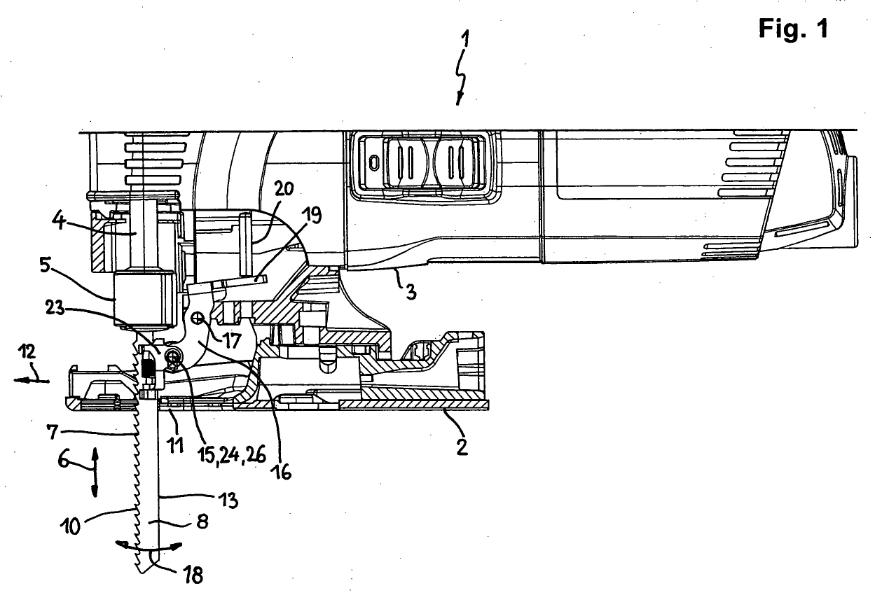

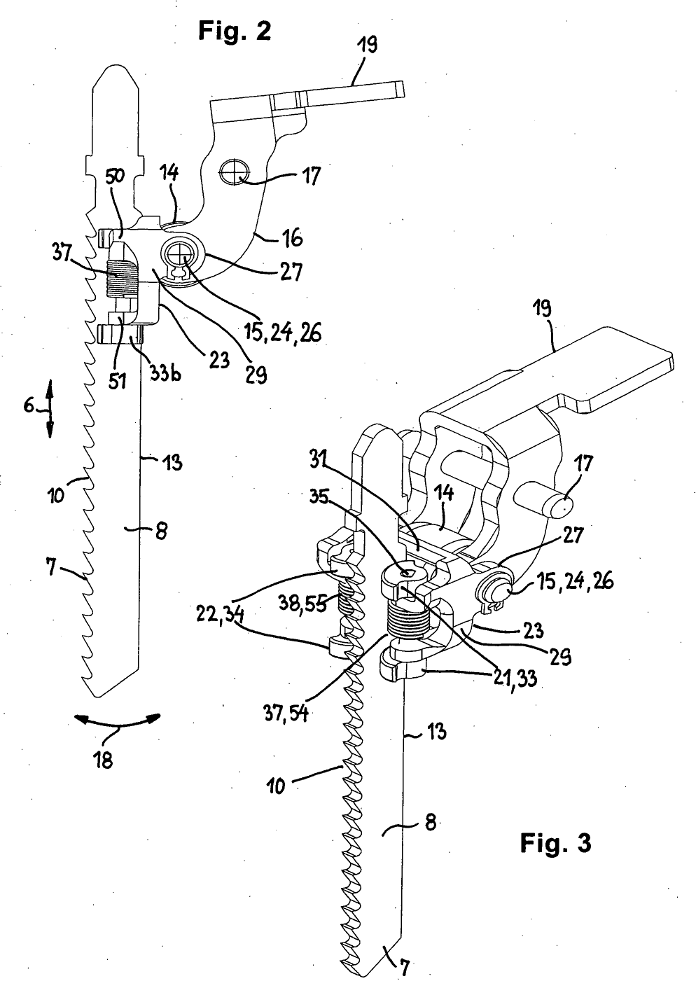

### DETAILED ACCOUNT OF WORKING EMBODIMENTS OF THE INVENTION

The jig saw 1 depicted in the drawings comprises a saw table 2 on which the workpiece ((not illustrated) to be sawn is laid. The jig saw 1 furthermore possesses, above the saw table 2, a drive unit 3, which in a conventional fashion possesses a drive motor and a transmission, by way of which during operation a pitman 4 with a saw blade holder 5 is driven to perform a reciprocating movement in the direction of the double arrow 6. The saw blade holder 5 serves to interchangeably mount a saw blade 7 participating in the reciprocating motion and performing the sawing action, the saw blade 7 having an elongated shape with two mutually parallel side faces and having its front edge appropriately fashioned to saw the workpiece with a row of teeth as illustrated.

The jig saw 1 is in the form of a hand saw and the housing of the drive unit 3 may be conveniently grasped by the user.

The saw blade 7 s arranged at the front end portion plug jig saw 1, and as already mentioned, is held at its top end portion by the saw blade holder 5. The saw blade 7 extends from the drive unit 3 essentially normally to the saw table 2 downward as far as a position underneath the saw table 2, which adjacent to the saw blade 7 has a forwardly open window in the table 11 for the passage of the saw blade 7. If the jig saw 1 is pushed along over the respective workpiece in the feed direction 12, the saw blade 7 moving up and down will cut a slot in the workpiece.

The drive unit 3 is mounted on the saw table 2 and is able to be tilted about the feed direction 12 and locked in the respective position of tilt. The drive unit 3 and with it the saw blade 7 can therefore be tilted to one side or the other so that the saw blade 7 is set obliquely to the workpiece and makes a corresponding oblique cut therein, as for example a miter cut. Further details of such tilting of the drive unit 3 are presently not of interest.

The saw blade 7 has its rear edge 13 opposite to the front edge 10 resting on a pendulum roller 14 rotatably supported on a roller axie 15 and carried on a pendulum roller holder 16 which is mounted for pendulum swinging motion about a pendulum axis 17 and during operation is drive synchronously with the reciprocating motion of the saw blade 7 to perform a pendulum movement so that the pendulum roller 14 acts with a pendulum motion on the rear edge 13 of saw blade 7 and the reciprocating motion 6 of the saw blade 7 is modulated with a pendulum component as indicated by the double arrow 18. In this context it is also to be observed that the pitman 4 is pivotally mounted to allow the pendulum movement. Furthermore the pitman 4 (and with it the saw blade 7) is subjected to a spring force directed against the pendulum roller 14.

The roller axis 15 and the pendulum axis 17 are parallel to one another and extend athwart the saw blade 7 past it.

The pendulum roller holder 16 has a lever arm 19 (which is opposite to the pendulum roller 14 in relation to the pendulum axis 17), on which a plunger 20 acts whose upward and downward motion is synchronous with the reciprocating motion 6 of the pitman 4.

In order to avoid the saw blade 7 being displaced to the side owing to the forces exerted by the sawing operation on the workpiece, for each of the two side faces 8 and 9 of the saw blade 7 there are respective guide elements 21 and 22 engaging it. Owing to the guide elements 21 and 22 engaging both side faces 8 and 9 of the saw blade 7 there is a lateral guiding effect for the saw blade 7 and accordingly a steadying action for the saw blade in the transverse direction. The guide elements 21 and 22 are located generally at the same level as the saw table 2 and in the state of the saw placed on the workpiece only slightly above it.

The two guide elements 21 and 22 are arranged on a guide holder 23 which is mounted to be able to be tilted about a pivot axis 24 parallel to the pendulum axis 17. The guide holder 23 constitutes a support means 25 for the rear edge 13 of saw blade which it engages during operation so that the guide holder 23, without changing its alignment in relation to the saw blade 7, performs a reciprocating pivotal movement corresponding to pendulum components 18 of the reciprocating motion of the saw blade 7.

The pivot axis 24 is disposed on the pendulum roller holder 16. It extends preferably coaxially to the axis 15 of the pendulum roller 14 so that the pivot axis 24 of the guide holder 23 and the axis 15 of the pendulum roller 14—provided in the working example illustrated here—may be constituted by a common bearing axis 26.

The guide holder 23 has two bearing portions 27 and 28 laterally flanking the pendulum roller 14 so that the pendulum roller 14 is disposed between the two bearing portions 27 and 28. The guide holder 23 has its bearing portions 27 and 28 mounted rotatably on the common bearing axis 26.

In accordance with a further convenient feature of the invention the guide holder 23 is arranged in a manner for axial movement in the direction of the pivot axis 24 carrying it so that it is always self-aligning on the saw blade 7.

The pivot axis 24 of the guide holder 23 could in principle also be arranged other than coaxially to the pendulum roller axis 15. The bearing means for the pendulum roller 14 and the guide holder 23 on the common bearing axis 26 is however space-saving and economic.

The guide holder 23 has two side portions 29 and 30 holding respectively one of the guide elements 21 and 22 and fitting over the saw blade 7 at the sides. Furthermore the support means 25 engaging the rear edge 13 of saw blade is constituted by two support ribs 31 and 32, which are arranged in the longitudinal direction of the saw blade 7 with a distance between them and connecting the two side portions 29 and 30, of the pivot axis 24 of the guide holder 23. In principle only one support rib could be present having such a size in the longitudinal direction of the saw blade 7 that the guide holder 23 would always remain aligned toward the saw blade 7 owing to its engagement.

The guide holder 23 has its support means 25 engaging the rear edge 13 of saw blade in the longitudinal direction of the saw blade 7 on either side of the guide holder 23.

It will be further seen from the drawing that the bearing portions 27 and 28, by which the guide holder 23 is borne on its pivot axis 24, are disposed on the lateral portions 29 and 30 of the guide holder 23.

The two guide elements 21 and 22 are respectively constituted by an eccentric element 33 and 34, which is carried in a rotatable fashion on the guide holder 23 for turning about an eccentric element axis 35 and 36 (i. e. the eccentric geometrical axis) parallel to the longitudinal direction of the saw blade 7 and is so loaded by a spring means 37 and 38 that the respective spring force is increased on turning of the respective eccentric element 33 and 34 to increase the distance between the two eccentric elements 33 and 34. Accordingly the two eccentric elements 33 and 34 are thrust, when a saw blade 7 is inserted in place, by the spring means 37 and 38 against the side facing faces 8 and 9 of the saw blade 7.

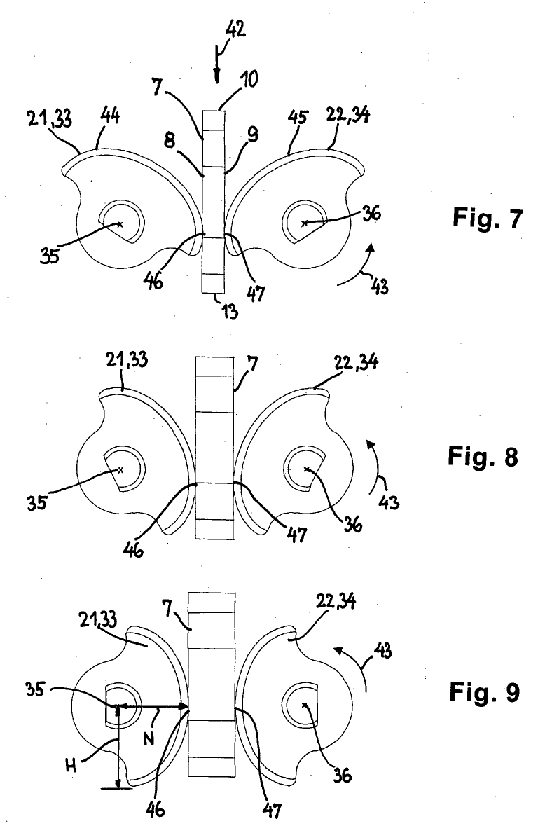

When the saw blade 7 is taken out the two eccentric elements 33 and 34 may each rest against an abutment 39 and 40 of the guide holder 23 so that the eccentric elements 33 and 34 are opposite and clear of each other to delimit a blade receiving gap 41 for the insertion of the saw blade 7. The blade receiving gap 41 is narrower than the thinnest saw blade to be employed. The insertion of the respective saw blade 7 takes place from the front in the direction of the arrow 42 (see FIG. 7) with the rear edge 13 of saw blade to the fore. When the rear edge 13 of saw blade engages the two eccentric elements 33 and 34 the eccentric elements 33 and 34 will turn in the direction 43 of rotation corresponding to the insertion direction 42 of the saw blade 7 against the spring forces exerted by the spring means 37 and 38 with the result that the blade receiving gap 41 widens out until it reaches the thickness of the respective saw blade 7.

For the removal of the saw blade 7 it is pulled out forward. The saw blade 7 then slides on the eccentric elements 33 and 34.

It will be apparent that the two eccentric elements 33 and 34 respectively have a peripheral face 44 and 45 extending eccentrically in relation to the respective eccentric element axis 35 and 36, such peripheral face engaging the saw blade 7. The FIGS. 7, 8 and 9 show saw blades 7 of different thickness between the two eccentric elements 33 and 34. Here the eccentric elements 33 and 34 are in different positions of rotation in accordance with the thickness of the respective saw blade so that they, dependent on the saw blade thickness, engage the respective saw blade 7 at different points 46 and 47 on their peripheral faces 44 and 45. In this respect the line connecting the respective eccentric element axis 35 and 36 with the respective peripheral point 46 and 47 should be as close as possible to an angle of 90 degrees to the lateral face 8 and 9 of the saw blade. For this purpose it is convenient for the peripheral faces 44 and 45 of the eccentric elements 33 and 34 each to correspond substantially to an ellipse, the ratio between the length N of the minor ellipse axis and the length H of the ellipse's major axis being less than 0.8. This results in a fair compromise for all saw blades thicknesses coming into question.

The two eccentric elements 33 and 34 may be designed with any desired length in the longitudinal direction of the saw blade 7 so that the saw blade 7 is guided for a sufficient length by the eccentric elements 33 and 34. It is however unnecessary to have any eccentric peripheral face 44 and 45 stretching along the full length. In this context it is convenient for the two eccentric elements 33 and 34 to be respectively constituted by two—in principle more than two would also be possible—separate eccentric members 33a and 33b or, respectively, 34a and 34b arranged with an axial clearance, i. e. in the direction of the eccentric element axis 35 and 36, such eccentric members being joined permanently (preferably integrally) together by an eccentric element axis member 48 and 49, which is rotatably mounted on the guide holder 23.

The guide holder 23 has a bearing arm 50, 51, 52 and 53 in an axial direction adjacent to each separate eccentric member 33a and 33b, 34a and 34b so that each eccentric member axis member 48 and 49 is rotatably carried on two of the bearing arms 50 and 51 and, respectively, 52 and 53. Here the two respective bearing arms 50 and 51 and, respectively, 52 and 53 are disposed with an axial clearance between them.

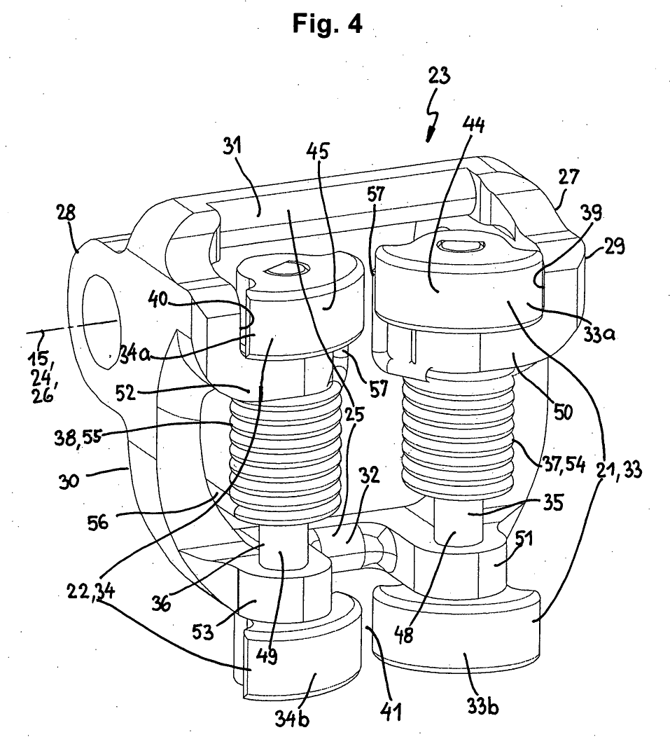

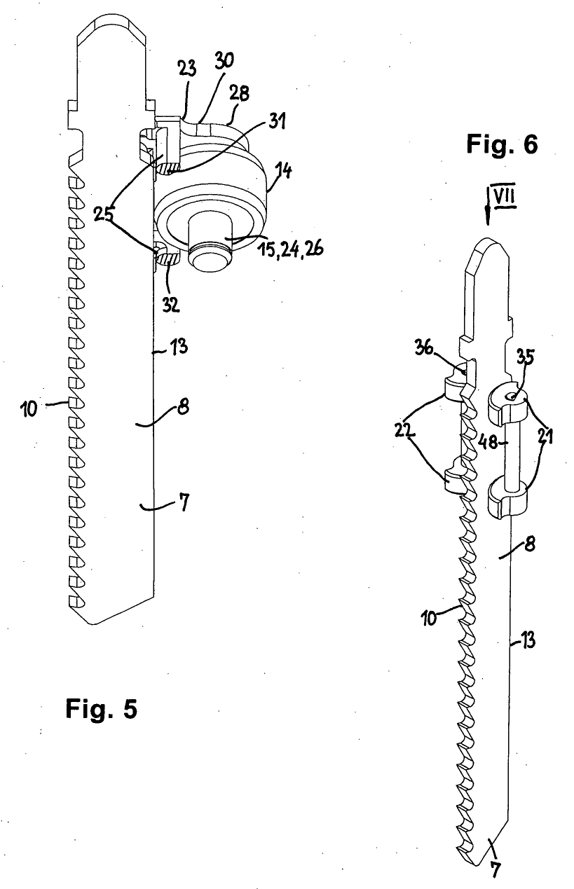

The two spring means 37 and 38 each loading one respective eccentric element 33 and 34 are preferably formed by a helical torsion spring 54 and 55 arranged coaxially in relation to the eccentric element axis 35 and 36, such spring bearing at one end against the guide holder 23 and at the other on the respective eccentric element 33 and 34. FIG. 4 more particularly shows that the respective one spring end 56 engages a stationary face on the guide holder 23 and the other spring end 57 engages the facing separate eccentric member 33a and respectively 34a.

The two helical torsion springs 54 and 55 are respectively disposed between the two bearing arms 50 and 51 and respectively 52 and 53 and have the respective eccentric element axis member 48 and 49 extending through them.

1. A reciprocatory saw, and in particular a jig saw, comprising a drive means for driving a saw blade with an elongated shape having two mutually parallel side faces and at a front edge adapted for working on a workpiece by sawing, for performing a reciprocating movement to and fro, a pendulum roller for engaging the rear edge of the saw blade and being arranged on a pendulum roller holder mounted for pendulum motion on a pendulum axis performing a reciprocating pendulum movement during operation so that the saw blade performs a reciprocating movement modulated by a pendulum component and two guide elements for lateral guidance of the saw blade on its two side faces, wherein the guide elements are arranged on a guide holder, which is pivotally mounted on a pivot axis parallel to the pendulum axis, and constitutes a support means for the rear edge of saw blade engaging same during operation so that the guide holder, while maintaining its alignment in relation to the saw blade, performs a reciprocating pivotal movement corresponding to the pendulum components of the reciprocating motion of the saw blade.

2. The reciprocatory saw as set forth in claim 1, wherein the pivot axis of the guide holder is disposed on the pendulum roller holder.

3. The reciprocatory saw as set forth in claim 2, wherein the pivot axis of the guide holder and the pendulum roller are coaxial.

4. The reciprocatory saw as set forth in claim 3, wherein the guide holder of the guide holder and the axis of the pendulum roller are constituted by a common bearing axis.

5. The reciprocatory saw as set forth in claim 4, wherein the guide holder comprises two bearing portions laterally overlapping the pendulum roller so that the pendulum roller is placed between the two bearing portions, the guide holder having its bearing portion support on the common bearing axis.

6. The reciprocatory saw as set forth in claim 1, wherein the guide holder is arranged for movement in the axial direction of the pivot axis supporting it.

7. The reciprocatory saw as set forth in claim 1, wherein the guide holder has two side portions respectively holding one of the guide elements and the support means is constituted by at least one support rib of the guide holder joining the two side portions.

8. The reciprocatory saw as set forth in claim 7, wherein the support means is constituted by two support ribs arranged with a clearance between them and in the longitudinal direction of the saw blade.

9. The reciprocatory saw as set forth in claim 1, wherein in the longitudinal direction of the saw blade the guide holder engages the rear edge of saw blade on either side of the pivot axis.

10. The reciprocatory saw as set forth in claim 5, wherein the bearing portions are arranged on the side portions of the guide holder.

11. The reciprocatory saw as set forth in claim 7, wherein the two guide elements are respectively formed by an eccentric element which is rotatably supported on an eccentric element axis, parallel to the longitudinal direction of the saw blade and is so loaded by a spring means that turning of the respective eccentric element to increase the distance between the two eccentric elements occurs against the spring force.

12. The reciprocatory saw as set forth in claim 11, wherein the two eccentric elements respectively have at least two separate eccentric members disposed with an axial clearance between them.

13. The reciprocatory saw as set forth in claim 13, wherein the separate eccentric members are permanently joined together by an eccentric element axis member which is rotatably mounted on the guide holder.

14. The reciprocatory saw as set forth in claim 11, wherein the two eccentric elements define a saw blade receiving gap for the saw blade with its rear edge to the fore, the blade receiving gap widening against the spring force on turning the eccentric elements in the blade insertion direction of the saw blade.

15. The reciprocatory saw as set forth in claim 11, wherein the respective spring means is in the form of a helical torsion spring arranged coaxially to the eccentric element axis, such axis being supported at one end on the guide holder and at the other end on the eccentric element.

16. The reciprocatory saw as set forth in claim 1, wherein the two eccentric elements respectively have an essentially elliptical peripheral face, the ratio between length of the minor ellipse axis and the length of the ellipse's major axis being less than 0.8.
